(19) United States
(12) Patent Application Publication
(10) Pub. No.: US 2019/0066040 A1
(43) Pub. Date: Feb. 28, 2019

(54) AUTONOMOUS COMMUNICATING SENSOR FOR MONITORING SPOIL, METHOD AND SYSTEM FOR TRACEABILITY OF SPOIL USING SUCH A SENSOR

(71) Applicants: Antoine Surmont, Voisins le Bretonneux (FR); David Boisdevesys, Vitry sur seine (FR); Mikael Bardy, Paris (FR)

(72) Inventors: Antoine Surmont, Voisins le Bretonneux (FR); David Boisdevesys, Vitry sur seine (FR); Mikael Bardy, Paris (FR)

(21) Appl. No.: 15/689,606

(22) Filed: Aug. 29, 2017

(51) Int. Cl. G06Q 10/08; H04Q 9/00

(52) U.S. Cl. CPC G06Q 10/0833; G06Q 10/0832; H04Q 9/00

(57) ABSTRACT

The invention relates to a system for traceability of spoil comprising:
an autonomous communicating sensor which is intended to be associated with loading of spoil and which comprises an accelerometer module,
at least one server adapted to receive from the sensor data relative to the measurements from the accelerometers which are transmitted regularly and/or event-related by said sensor, said server comprising a computer adapted to process said data to deduce therefrom an item of information on the transport of the loading of spoil and its possible unloading.

The present invention relates to the traceability of spoil originating from construction sites.

GENERAL TECHNICAL FIELD AND PRIOR ART

A frequent feature of construction sites (public works, construction, earthwork, etc . . . ) is the excavation of a substantial quantity of spoil.

In France for example, the quantity of spoil which will be generated by works undertaken in “Grand Paris” over twenty years is estimated at over 40 million tonnes.

To date, waste output from construction sites is transported by trucks to collection sites of exchange platform type or to intermediate sites for storage before evacuation by river or by railway. Trucks are weighed on the collection site scales and at that point make a declaration on the qualification of the spoil, as well as on tonnage, date, time, etc.

These declarations cannot be controlled.

As it is, traceability of spoil, such as their method of evacuation and their evaluation, is now a major priority for leading operators.

In the mining industry especially, equipment for dump trucks for tracking their route is already known. In this respect reference could be made for example to patent application US 2016/0231750 or even to patent U.S. Pat. No. 5,327,347

This equipment is incorporated into trucks and is particularly complex and expensive.

Therefore there is a need for a simple and inexpensive solution for better tracking of quantities and quality of spoil generated by these construction sites, as well as their evacuation to various collection sites they are intended for.

### GENERAL PRESENTATION OF THE INVENTION

A general aim of the invention is to propose a solution enabling the traceability of spoil.

In particular, an aim of the invention is to propose a solution for ensuring the traceability of different types of spoil to be evacuated and stored at different collection sites.

Yet another aim of the invention is to monitor the route these spoil.

Yet another aim is to have means for verification of the elements declared at the collection sites or the intermediate sites during unloading.

Another aim is to propose a system which detects anomalies in routing or unloading (uncontrolled deposit, shifting after unloading, etc.).

Another aim also is to propose a solution which easily audits the way in which spoil is evacuated and monitor the providers in charge of this evacuation.

Yet another aim is to propose a system suitable to be used without the need for extra infrastructure, including in zones without GPS coverage.

Yet another aim of the invention is to propose an autonomous and non-intrusive system which in particular needs no hardware adaptation (especially trucks and their dumps).

Therefore, according to a first aspect the invention proposes a sensor for monitoring loading of spoil loaded into a dump of a truck, comprising an accelerometer module in a casing, characterized in that said casing is adapted to be loaded with the spoil or be fixed on the dump of a truck and in that the sensor is an autonomous communicating sensor which comprises in said casing:
an autonomous power supply,
processing and communication means supplied by said supply and receiving measurements from the accelerometer module, said processing means being adapted to transmit data relative to the measurements from the accelerometers to a remote processing server.

In this way, the major advantage of such a sensor is being autonomous both from the electrical point of view and the communication means it uses. In this respect no adaptation of trucks is needed.

As will be evident, the sensor casing can be fitted with means for fixing the latter to the dump of a truck.

As a variant, it can also be intended to be linked not to the truck dump, but to loading of spoil onto which it is thrown, for example.

It can be made anonymous and be made available in an envelope, giving it the appearance of spoil material. As an alternative, the aim may be to have it easy to identify it in loading of spoil and make it clearly identifiable by a specific bright color.

Likewise, the sensor can comprise inert and/or biodegradable/decomposable elements/materials and/or in sufficiently low quantity to be accepted by environmental standard tolerances.

Also, according to another aspect, the invention proposes a method for traceability of spoil wherein:
a load of spoil is loaded into a truck dump or
said dump is fixed with

an autonomous communicating sensor for monitoring loading,

said sensor comprising a casing adapted to be loaded with the spoil or be fixed to the dump of a truck:
an accelerometer module,
an autonomous power supply,
processing and communication means supplied by said supply and receiving measurements from the accelerometer module, said processing means being adapted to transmit data relative to the measurements from the accelerometers to a remote processing server,

and wherein:
data relative to measurements from the accelerometers which are transmitted regularly and/or event-related by said sensor to the server,
said server deduces from the data received an item of information on the transport of the loading of spoil and its possible unloading.

In particular, the server processes the received data to detect on said data transmitted by the sensor a lifting movement of truck dump during unloading.

As a variant also, the server stores over time the data transmitted by the sensor and, after detection of unloading, processes the data transmitted by the sensor before and after said unloading to estimate tonnage unloaded by a truck.

According to yet another aspect, the invention proposes a system for traceability of spoil comprising:
a sensor for monitoring loading of spoil loaded in a dump of a truck, said sensor comprising an accelerometer module in a casing, characterized in that said sensor is autonomous and comprises in said casing:
   an autonomous power supply,
   processing and communication means supplied by said supply and receiving measurements from the accelerometer module, said processing means being adapted to transmit data relative to the measurements from the accelerometers,
said system further comprising at least one server adapted to receive from the sensor data relative to the measurements from the accelerometers which are transmitted regularly and/or event-related by said sensor, said server comprising a computer adapted to process said data to deduce therefrom an item of information on the transport of the loading of spoil and its possible unloading.

Such a system is advantageously completed by the following different features taken singly or in combination:
the communicating sensor and the server exchange over a network of long-range network (LoRa) type;
the network is further adapted to transmit to the server an item of information on the positioning of the sensor when the latter exchanges with said server;
the system comprises a reader for pairing by a user on site between an identifier of said sensor and information relative to loading of spoil.

### PRESENTATION OF THE FIGURES

Other features and advantages of the invention will emerge from the following description which is purely illustrative and non-limiting and must be considered with respect to the appended figures in which:

FIG. 1 illustrates a first possible embodiment enabling traceability of spoil evacuated by truck from the loading site to the unloading site;

FIG. 2 illustrates an example of a connected sensor which can be used in the embodiment of FIGS. 1 to 3;

FIGS. 3 and 4 illustrate an example of a system according to the embodiment of FIG. 1;

FIG. 5 illustrates another possible embodiment for the invention.

### DESCRIPTION OF SEVERAL EMBODIMENTS

### Example of Container Tracking

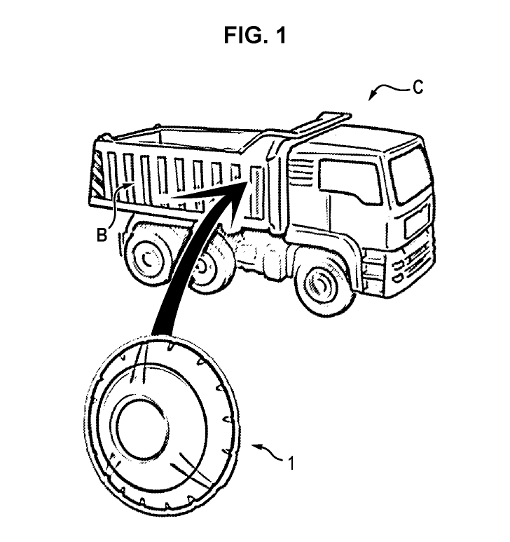

In the embodiment illustrated in FIG. 1, a sensor 1 is positioned on the dump B of a truck C intended to be loaded with spoil from a construction site.

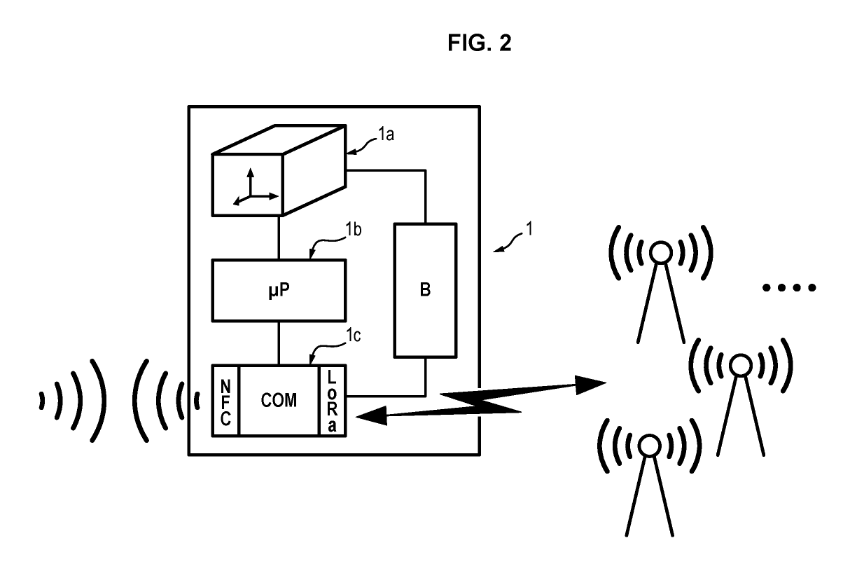

The sensor 1 comprises an accelerometer module 1a (three-axes), communication means 1b and a microcontroller 1c comprising means for storing and processing data from the accelerometer and managing the exchanges between the accelerometer module and the communication means (FIG. 2).

A battery B is also provided. This battery B can have a long service life (several years) or can be rechargeable. It ensures the electrical autonomy of the sensor 1 relative to the truck and its dump, the sensor 1 being independent of the truck and the dump in its operation.

This sensor is placed on the truck dump by a mechanical fastening system: magnet, rivet/screw, clip, double-sided adhesive or adhesion, etc.

While this is being put in place, pairing is conducted between the truck C and the sensor 1 (initialization), an external database storing the information giving the correspondence between the identifier of the sensor 1 and the identification data of the truck.

A second type of pairing is then conducted each time the truck C is loaded.

This pairing is conducted by means of a reader 2 and links identification of the sensor 1 to data relative to loading of the dump.

For this purpose, the reader 2 (for example a mobile of personal assistant type) comprises NFC means for interrogating the memory means of the microcontroller 1c. Other reading technologies are possible, of course (reading a QR Code affixed to the sensor for example).

The reader 2 further comprises interface means enabling a user to input the different data relative to loading (manual input via a touchpad for example).

These data can be the following:
type of spoil,
tonnage,
place and time of loading,
person responsible for loading,
etc.

The pairing data input in this way are transmitted by the reader 2 to an external server 3 which manages monitoring of the spoil.

Once pairing is done, the sensor 2 emits regularly (every fifteen minutes for example) or event-related to the external server 3.

Communication is done for example via LoRa technology.

Processing is carried out over the LoRa network to add extra data (time-based marking) or calculate data linked to infrastructure (positioning) or even to complete pre-processing on data from the sensors (filtering, conciliation, analysis of type “big data”, etc . . . ).

At the time of communication especially:
the sensor 2 provides said server 3 with data relative to the measurements by the accelerometers;
triangulation is done via the LoRa network on time exchanges between the sensor 2 and the base stations of the queried network to deduce therefrom the geographic position of the sensor 2 and of the truck C.

The data collected in this way are processed by the manager server 3 which detects anomalies as to unloading performed by the truck, when needed.

In particular, analysis of data collected by the accelerometers in particular detects when the dump is lifted corresponding to unloading (tilting around 45°).

The coherence between the geographic zone, where the truck C is when the dump is raised, and the deposit zone, which was normally expected, is then verified.

When incoherence is detected, the server 3 sends an alert message to a manager of the system which in turn can be connected to the server 3 via different interfaces 4.

The data from the accelerometers can further be processed to verify coherence between the tonnage declared at the unloading site and the real unloaded tonnage.

The loading tonnage of the dump B does have an effect on the vibrations to be seen by the accelerometers. The curves recorded by the latter, especially the main vibration frequencies which will appear there, will therefore be different depending on whether the dump B is fully empty or the intervening unloading was partial only.

In a possible embodiment, data collected by the accelerometers from the module 1a once the truck C sets off again after unloading are processed by the server 3 to detect partial unloading, if needed.

When such partial unloading is detected, the server 3 sends an alert message to the manager.

The server 3 can also comprise learning means of neuronal type or “machine learning” or “deep machine learning” type and more generally all usual processing algorithms for data of “big data” type, these means linking the profiles of accelerometer curves (or differentials between the accelerometer “loaded dump” curves and the “empty dump” curves) to orders of magnitude of loading tonnage for a given truck. Learning is done on the different curves stored for the truck and on the different successive tonnages it loads.

### Example of Content Tracking

As a variant, the autonomous communicating sensor cannot be fixed mechanically to the dump.

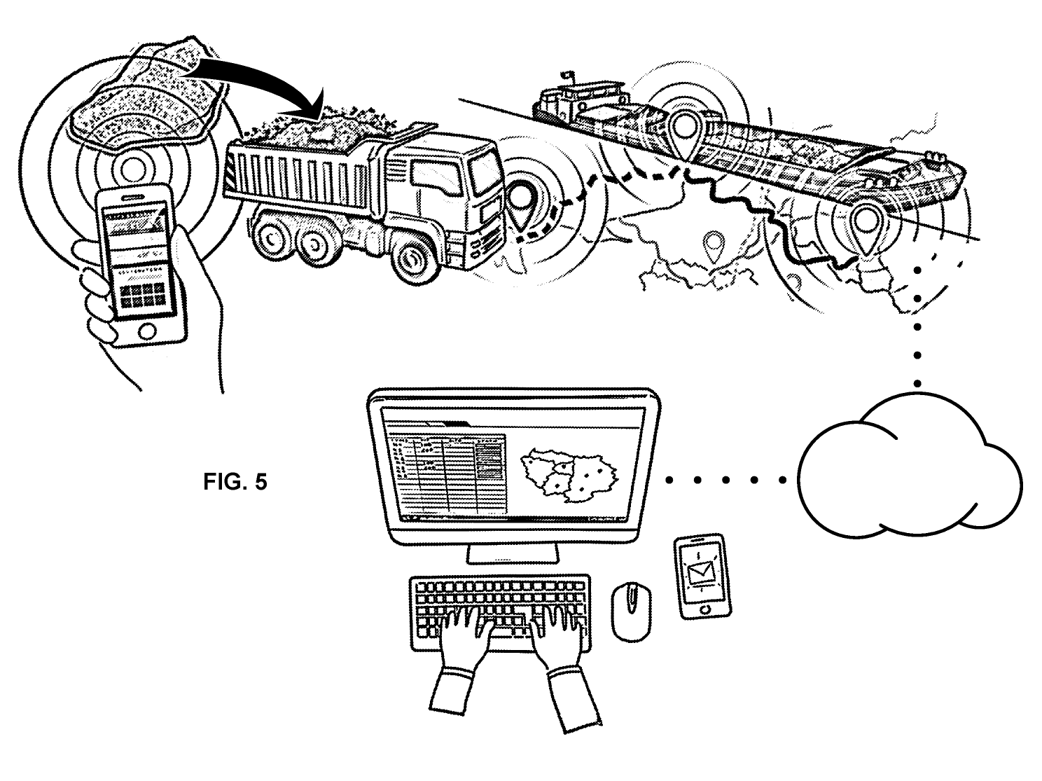

As FIG. 5 shows, it is intended to be associated with loading at the time when the latter is constituted, for example by being thrown among the spoil.

The sensor 1 can for example be integrated into an envelope having the appearance of a spoil stone or even into a bright-colored envelope making it particularly visible (envelope of fluorescent orange color type, for example).

This sensor will comprise elements/materials not suitable for denaturing qualification of the spoil. These materials are either considered inert, are biodegradable/decomposable, or in sufficiently low quantity to be accepted by environmental standard tolerances.

The advantage of such a sensor is to enable monitoring not only of the travel of the truck having loaded the spoil but also of the transfer of the spoil to another type of container.

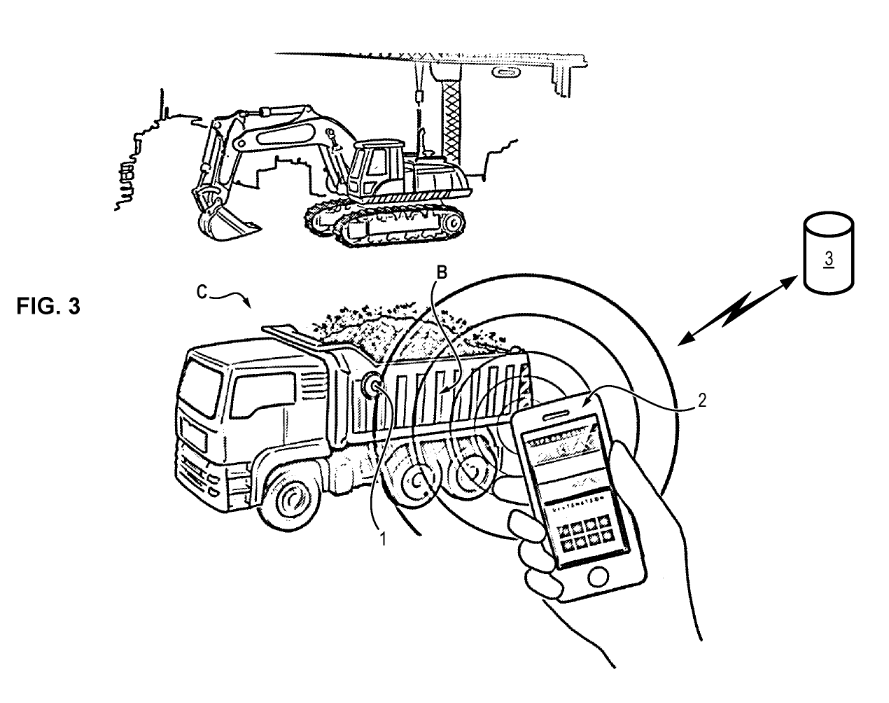

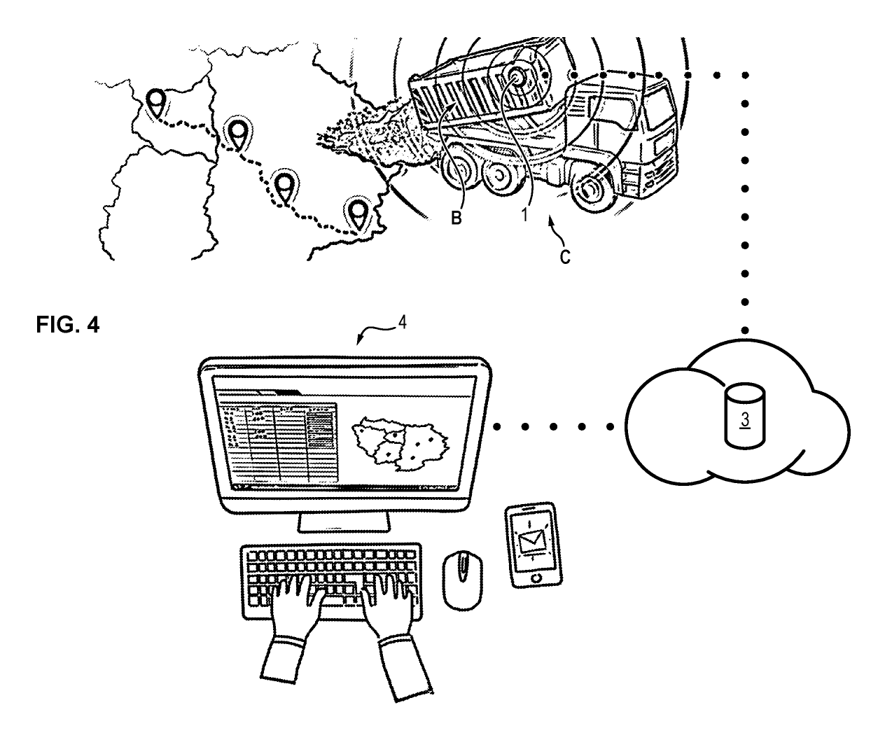

It can be used as a complement to that presented in reference to FIGS. 1 to 4, for example to allow a client to audit the information supplied by the project manager.

As will be evident, the major advantage of the proposed system is being autonomous and non-intrusive: it requires neither additional infrastructure nor adaptation of trucks or dumps.

1. A sensor for monitoring spoil loaded into a dump of a truck, comprising an accelerometer module in a casing, characterized in that said casing is adapted to be loaded with the spoil or be fixed on the dump of a truck and in that the sensor is an autonomous communicating sensor and comprises in said casing:
an autonomous electrical power supply,
processing and communication means supplied by said supply and receiving measurements from the accelerometer module, said processing means being adapted to transmit data relative to the measurements from the accelerometers to a remote processing server.

2. The sensor according to claim 1, characterized in that the casing comprises an envelope giving it the appearance of spoil material or a bright-colored envelope.

3. The sensor according to claim 1, characterized in that it comprises inert and/or biodegradable/decomposable elements/materials and/or in sufficiently low quantity to be accepted by environmental standard tolerances.

4. A method for traceability of spoil wherein
a load of spoil is loaded into a truck dump or
said dump is fixed with,
a sensor for monitoring spoil,
said sensor being an autonomous communicating sensor comprising a casing adapted to be loaded with the spoil or be fixed to the dump of a truck:
an accelerometer module,
an autonomous power supply,
processing and communication means supplied by said supply and receiving measurements from the accelerometer module, said processing means being adapted to transmit data relative to the measurements from the accelerometers to a remote processing server,
and wherein:
data relative to measurements from the accelerometers which are transmitted regularly and/or event-related by said sensor to the server,
said server deduces from the data received an item of information on the transport of the loading of spoil and its possible unloading.

5. The method according to claim 4, characterized in that the server processes the received data to detect on said data transmitted by the sensor a lifting movement of truck dump during unloading.

6. The method according to claim 4, characterized in that the server stores over time the data transmitted by the sensor and, after detection of unloading, processes the data transmitted by the sensor before and after said unloading to estimate tonnage unloaded by a truck.

7. A system for traceability of spoil comprising:
a sensor for monitoring loading of spoil loaded in a dump of a truck,
said sensor comprising an accelerometer module in a casing,
characterized in that said sensor is autonomous and comprises in said casing:
an autonomous power supply,
processing and communication means supplied by said supply and receiving measurements from the accelerometer module, said processing means being adapted to transmit data relative to the measurements from the accelerometers,
said system further comprising at least one server adapted to receive from the sensor data relative to the measurements from the accelerometers which are transmitted regularly and/or event-related by said sensor, said server comprising a computer adapted to process said data to deduce therefrom an item of information on the transport of the loading of spoil and its possible unloading.

8. The system according to claim 7, characterized in that the communicating sensor and the server exchange over a network of long-range network (LoRa) type.

9. The system according to claim 7, characterized in that the network is further adapted to transmit to the server an item of information on the positioning of the sensor when the latter exchanges with said server.

10. The system according to claim 7, characterized in that it comprises a reader for pairing by a user on site between an identifier of said sensor and information relative to loading of spoil.
